(19) United States
(12) Patent Application Publication
(10) Pub. No.: US 2006/0237035 A1
(43) Pub. Date: Oct. 26, 2006

(54) Dishwasher with food particle disposal system

(75) Inventors: Jerry Wayne Ferguson, Greenwood, MS (US); David Clinton Weaver, Greenwood, MS (US); John Patrick Picardat, Greenwood, MS (US); John Frederick Morrison, Greenwood, MS (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Viking Range Corporation

(21) Appl. No.: 11/170,255

(22) Filed: Jun. 29, 2005

Related U.S. Application Data
(60) Provisional application No. 60/674,509, filed on Apr. 25, 2005.

(51) Int. Cl. B08B 9/20; B08B 7/04; B08B 3/00; C23G 1/36; B08B 3/04

(52) U.S. Cl. 134/10; 134/25.2; 134/18; 134/56 D; 134/58 D; 134/104.2

(57) ABSTRACT

A dishwasher incorporating a food waste disposal system and has a sump formed in its lower portion and a drain pump located in the sump is provided. The drain pump includes a motor driving an impeller and a chopping blade. A fine filter is positioned before the inlet portion of a wash pump in the sump to collect and concentrate food particles held adjacent the drain pump. An electronic controller, which controls the dishwasher cycle and the wash and drain pumps, causes the chopping blade to rotate and chop any food particles held adjacent the drain pump. An electrically controlled valve, operated by the electronic controller, is in the drain line of the drain pump and can be pulsed on and off during operation of the dishwasher to allow removal of some food particles in the wash water at any intermediate point of the cycle.

### CROSS-REFERENCE TO RELATED APPLICATION

This application claims the benefit of U.S. Provisional Application 60/674,509 filed Apr. 25, 2005, incorporated by reference herein in its entirety.

### FIELD OF THE INVENTION

The present invention relates to a dishwasher, more particularly to a dishwasher with a disposal system.

### BACKGROUND OF THE INVENTION

Conventional dishwashers generally fail to provide a mechanism for grinding food particles washed off the dishes during a wash cycle. However, in conventional dishwashers with provision for grinding food particles, grinding is performed in the main wash hydraulic system, typically at the wash pump inlet. In the wash phase of such conventional dishwashers, wash water would become a diluted slurry of food, soil, detergent, and wash water. At the end of the wash phase, the drain pump would be energized to pump the slurry down the drain. However, the surface of the dishes, the interior walls of the tub, and any water not drained completely by the drain pump would still be coated with a film of food, soil, detergent, and water slurry. In order to clean fully the dishes by the end of the wash cycle, a number of fresh water refill and drainage phases are required to dilute and clean the dishwasher tub. This refill and drain method of operation uses a relatively large amount of water and energy to clean a load of dishes.

Other conventional dishwasher designs attempt to separate the food and soil from the wash water as early as possible to prevent such food and soil from being ground up and dissolved in the wash water. These designs provide collection chambers to collect and hold the food and soil until the drainage phase to ensure that a maximum of food soil is removed from the dishwasher early in the cycle. Although early removal of food soil results in a cleaner overall initial wash cycle, a diminished need for additional rinse cycles, and an overall savings of water and energy, these conventional systems present numerous problems. For example, if the drain water passes only once through the grinding assembly rather than being recirculated therethrough, any food particles present therein may not be ground finely enough to prevent accumulation in, or otherwise fouling of, the drainpipe or downstream plumbing. Moreover, since a collection or holding chamber in a dishwasher requires additional water merely to fill the collection chamber, any cost savings are negated as additional water is used for each fill and as increased amounts of residual water remain in the bottom of the sump after the dishwater has been pumped out. Additionally, some grinding assemblies provide blades in close proximity to perforated plates, requiring design adherence with close tolerances between the blade and the plate. As the tolerance and design adherence increases, costs and reliability problems typically increase.

Conventional dishwashers also have drainage pumps that generally include relatively large clearances between impellers and volute or housing to ensure that any debris, which reaches the drain pump, does not interfere with the pump. Pumps with relatively large internal clearances generally are inefficient at expelling air that collects in the volute and therefore an “air lock” or collection of air can form, thus causing the pump's impeller to rotate or spin in the air pocket and result in inefficient pumping.

Further still, most conventional dishwashers include a check valve in the discharge from the drainage pump to prevent dirty drainage water from leaking into the wash water—especially from, and due to, the orientation of the drain line. These check valves generally are simple rubber flap valves that can become ineffective as the rubber wears or ages.

### SUMMARY OF THE INVENTION

The present invention provides a drainage pump volute that acts as a collection chamber for food soil during the wash phase of the dishwasher cycle and that provides for minimum water usage during each cycle. The volute allows air that has been trapped in the drainage pump to escape through the pump's inlet without diminishing pump performance. The air passage provided is not large enough to impact the hydraulic performance of the drain pump. Generally, the drain pump has a blade integrally molded therein and operates without a mating perforated plate.

At the discharge of the drain pump, the present system includes an electrically actuated valve that can be held closed while the drain pump runs to allow the drain impeller and attached blade to complete multiple passes through the food soil in the confined area of the drain pump's volute to more completely grind the food debris. These multiple passes act to grind completely the hardest food soils—analogous to a blender or food processor. Once the food soil has been sufficiently reduced in size, the valve of the discharge is opened to allow the water and food soil slurry to be pumped down the drain. Because the present drain valve can be operated as a part of, and by, the dishwasher control system, the drain valve can be opened at any time to allow partial discharge of the food soil slurry during the wash phase, at the end of the wash phase, or during the drainage phase.

### BRIEF DESCRIPTION OF THE DRAWINGS

FIG. 1 is a front perspective view of a dishwasher.

FIG. 2 is a schematic view of the dishwasher of FIG. 1.

FIG. 3 is a schematic view of the dishwasher with the wash pump operating.

FIG. 4 is a schematic view of the dishwasher with the drain pump activated.

FIG. 5 is a schematic view of the dishwasher with the drain valve open.

### DETAILED DESCRIPTION OF THE DRAWINGS

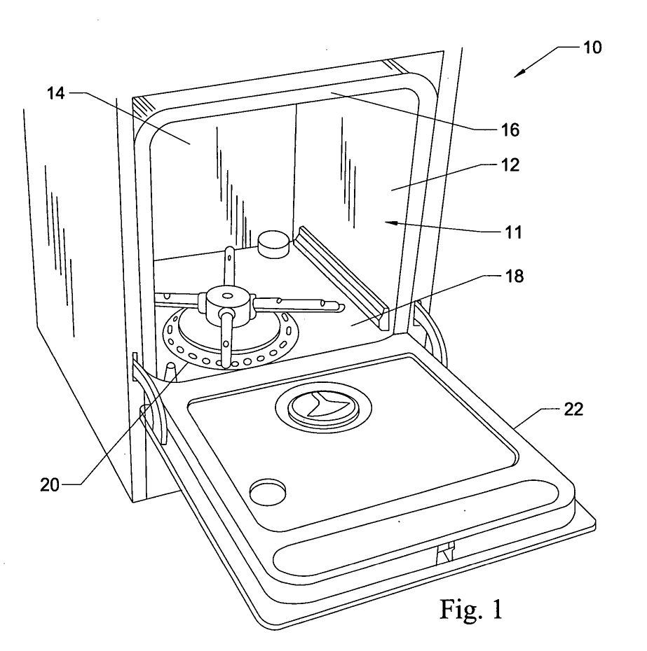

Referring now in more detail to the drawing figures, wherein like reference numerals refer, where appropriate, to like parts throughout the several views, FIG. 1 is a front perspective view of a dishwasher. FIG. 1 illustrates a dishwasher 10 with a tub 11 that has opposed sidewalls 12, a rear wall 14, a top wall 16, and a floor 18. A sump 20 is formed in the floor 18 of the dishwasher 10. The dishwasher 10 also includes a door 22, which is closed during operation.

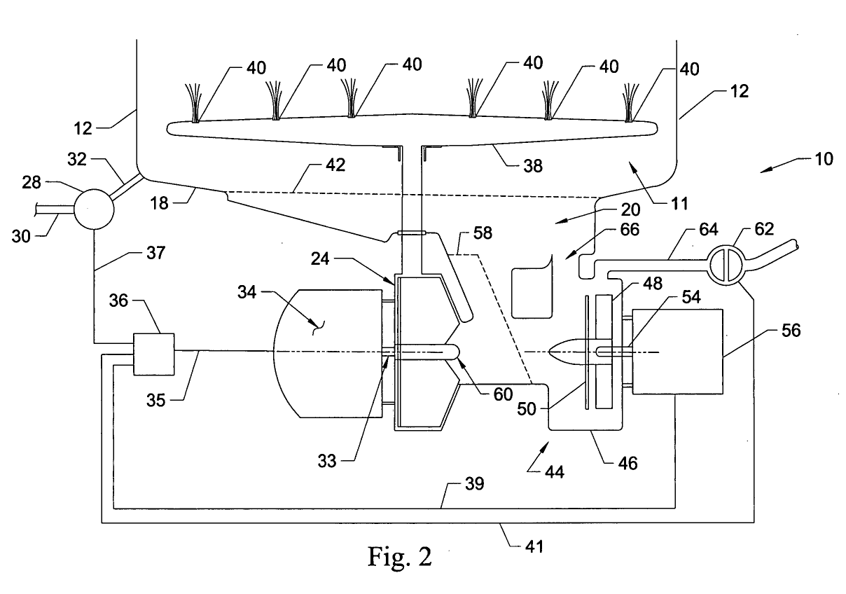

FIG. 2 illustrates a schematic side view of the dishwasher 10 of FIG. 1. FIG. 2 shows the dishwasher 10 with a wash pump 24 situated on the same level as, or below, the sump 20. Inlet wash water from the sump is drawn into the wash pump 24 through a suction inlet 60. The wash pump 24 is driven by an electric motor 34, which is connected, to an electronic controller 36 by line 35, through a motor shaft 33. The electronic controller 36 controls the wash cycle sequences of the dishwasher 10. Fresh inlet water is supplied to the sump 20 through a valve 28 connected to a supply line 30. A line 32 connects valve 28 to the dishwasher tub 11 where the water then runs into the sump 20. Although valve 28 can be any valve capable of performing the functions detailed herein, valve 28 is shown in the figures herein is an electronic control valve that is controlled by controller 36. Line 37 connects controller 36 with valve 28. The pump 24 supplies water to at least one wash arm 38. The wash arm 38 generally has a number of spray outlets 40 disposed therein or thereon for spraying water onto the dishes in the dishwasher.

A course filter 42 provides a barrier for large objects in the dishwasher and prevents them from entering into the sump 20. The course filter 42 is capable of trapping large objects, such as silverware or larger pieces of food.

In operation, pump 24 re-circulates water through the dishwasher to provide washing action onto the dishes. The pump 24 is capable of drawing water inside the dishwasher through a suction inlet 60. The flow of water proceeds into the dishwasher, from the outside supply line 30 or suction inlet 60, through the spray arm 38, and is directed to the outlets 40 to provide washing action onto the dishes in the dishwasher 10.

The present dishwasher incorporates a drain pump 44 generally located in or adjacent the sump 20. The drain pump housing 46 or volute includes an impeller portion 48 and a chopping blade 50 mounted on a common shaft 54 and driven by a drive motor 56. The drive motor 56 is controlled by the electronic controller 36 and is connected thereto by line 39. Water is re-circulated through the dishwasher 10 during the washing cycle, with large objects or particles being captured by the course filter 42. A fine filter 58 captures the finer particles of food and soil and holds them away from the inlet 60 of the wash pump 24. As the wash pump 24 operates, food particles are removed from circulation and washing efficiency of the dishwasher improves.

Due to the drawing action of the pump 24, soil particles in the sump will tend to collect or accumulate near the fine filter 58 and the water therein. In contrast to previous dishwashers, the motor 56 of the drain pump 44 is capable of being pulsed on and off during the washing cycle to chop food by the chopping blade 50 into finer particles to prevent clogging of drain lines.

A drain valve 62, shown in the figures in an outlet line 64 extending away from the drain pump 44, typically is closed. When the drain valve 62 is closed, food particles are allowed to make multiple passes through chopping blade 50 to be chopped into fine particulate matter, thereby easing disposal. The drain valve 62 is controlled by the electronic controller 36 and is connected thereto by line 41. The drain valve 62 may be opened for short periods of time, even intermediately during the washing cycle, to allow discharge of food particles. Although a small amount of water generally is discharged during such an intermediate discharge by the drain valve, the resulting reduction of water is not disruptive to the overall washing cycle of the dishwasher 10. Further, intermediate discharge of the chopping and discharge of the food particles collected in the sump 20 can be delayed until the final drain process or can take place at any time during the entire washing cycle. This flexibility of chopping and discharge at intermittent times helps maintain clean wash water during the entire cycle.

Since drain pump 44 generally is shaped to allow relatively large solid objects to be drawn into the housing, the clearance between the impeller 48 and the housing 46 is graciously formed. However, such a relatively large clearance tends to render the pump inefficient when the pump 44 ingests air bubbles. If an air pocket of sufficient size forms in the pump housing 46, the pump may become air locked and may not pump water, resulting in reduced draining efficiency of the dishwasher. The housing of the drain pump 44 includes a small passage 66 formed in the sump 20. This small passage 66 allows air trapped in the pump housing 46 to escape, generally by gravity, instead of collecting and/or contributing to the formation of an air pocket in the pump housing 46. Passage 66 generally is disposed in a forward portion of the pump housing 46 at a relatively low-pressure area proximate the perimeter of the housing 46. Since passage 66 generally is, or is in, a lower pressure area, very little water is pumped out of the passage 66 when the drain pump is fully primed. However, the configuration of passage 66 allows any air trapped in the perimeter of the housing to escape easily through the passage 66.

The electrically controlled drain valve 62 is included adjacent the discharge of the drain pump 44 to prevent any dirty or soiled water from a previous pump out of water or waste water from returning into the dishwasher sump 20. Valve 62 is especially useful when the dishwasher must pump out to a higher level, creating a higher drain line backpressure, such as when the dishwasher is located in a basement. Further, since valve 62 is electrically controlled, it may be opened and closed intermittently during the cycle and allow the water to be partially cleaned, exchanged, or augmented during the wash cycle.

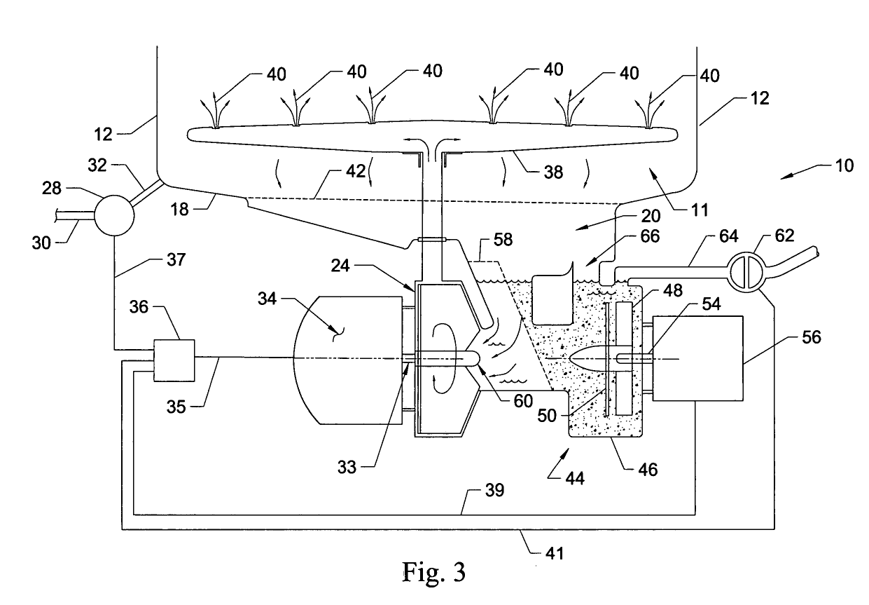

FIG. 3 is a schematic view of the dishwasher with the wash pump operating. The dishwasher 10 shown in FIG. 3 generally has a substantially full fill of water in dishwasher tub 11. Also, the wash pump 24 is operating with food soil being directed into, and being collected in, the drain pump housing by the filter screen 58. In FIG. 3, the drain valve 62 is closed and the drain pump 44 is not activated.

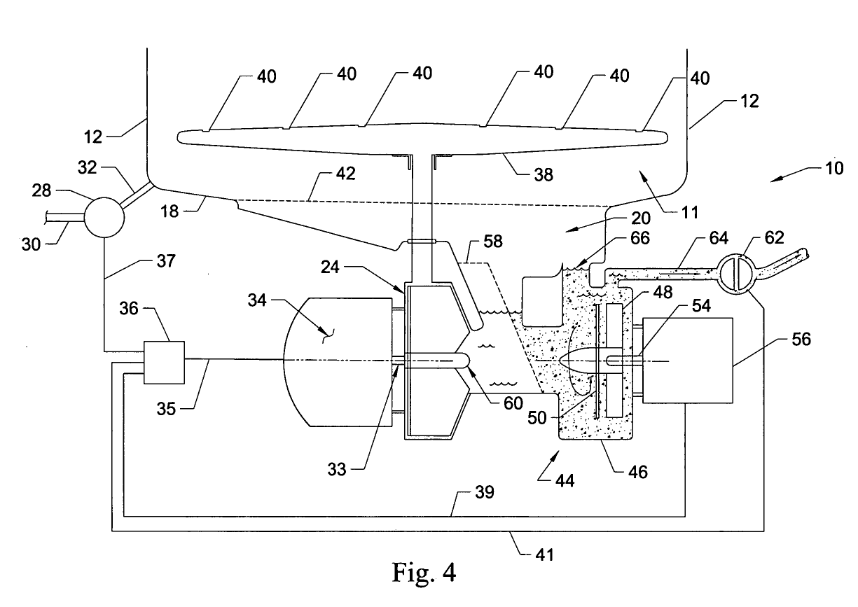

FIG. 4 is a schematic view of the dishwasher with the drain pump activated. In FIG. 4, the activated drain pump allows the chopping blade 50 to grind the food soil in the drain pump housing. The drain valve 62 can remain in a closed position for enough time to allow the blade to grind the food soil better. The main pump 24 may or may not be operating during the wash phase shown in FIG. 4.

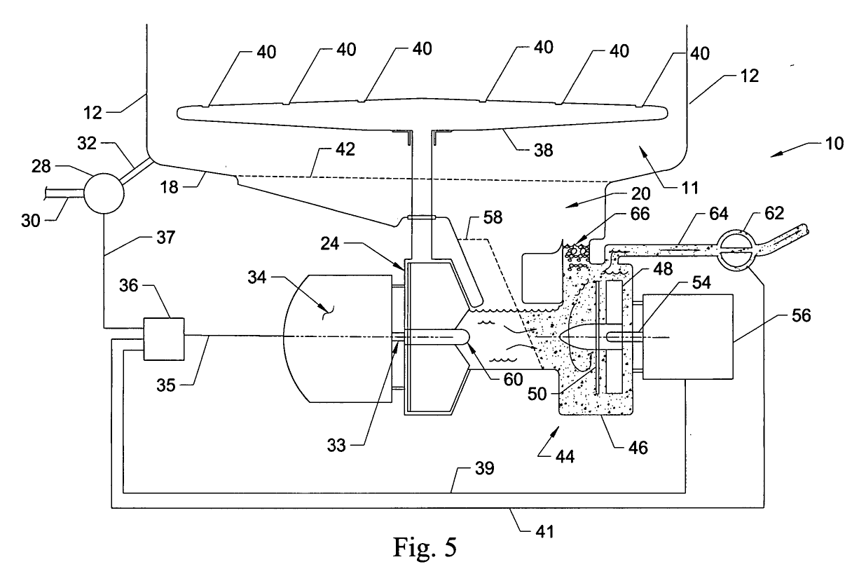

FIG. 5 is a schematic view of the dishwasher with the drain valve open. The food soil in FIG. 5 is being ground by the chopping blade 50 and the drain valve 62 is open to allow the soil/water mixture to be pumped out the outlet line 64 and through the valve 62. Once the draining of the soil/water mixture is complete, the valve 62 closes to prevent dirty drain water from reentering the dishwasher 10. Although the wash pump 24 can be on or off in FIG. 5, typically, the drain pump is on. Air bubbles are able to escape from the pump housing through air passage 66.

After completing the grinding cycle shown and discussed in FIGS. 2-5, the dishwasher typically will begin the cycle again while the dishwasher is still in the wash mode. If the wash mode has completed, the dishwasher 10 can finish the steps illustrated in FIGS. 2-5 and proceed to the drying cycle.

While the invention has been disclosed in its preferred form, it will be apparent to those skilled in the art that many modifications, additions, and deletions can be made therein without departing from the spirit and scope of the invention or its equivalents as set forth in the following claims.

What is claimed is:

1. A dishwasher incorporating a food waste disposal system comprising:
a dishwasher tub having a sump formed in a lower portion;
a drain pump having a housing located in the sump, said drain pump including an impeller mounted in said housing and a drive motor connected to said impeller by a shaft;
a chopping blade mounted in front of said impeller on said shaft;
a wash pump located in said sump;
a fine filter in an inlet portion of said wash pump and being capable of collecting food particles washed from articles in said dishwasher and holding said food particles; and
an electronic controller connected to said drain pump and said wash pump for controlling a wash cycle of said dishwasher, wherein the electronic controller is capable of activating the drain pump to rotate said chopping blade to chop the food particles into fine pieces.

2. The dishwasher of claim 1 further including a course filter positioned in said tub above said fine filter.

3. The dishwasher of claim 1 further including at least one spray arm, having a plurality of spray outlets, in fluid communication with said wash pump.

4. The dishwasher of claim 1 further including a passage formed in said drain pump housing capable of allowing escape of air trapped by said impeller during operation of said drain pump.

5. The dishwasher of claim 4 wherein said passage is located in a forward portion of said drain pump housing in a relatively low pressure area, which allows air, but relatively little water to escape through said passage.

6. The dishwasher of claim 1 further including an electrically controlled valve controlling the discharge of said drain pump to a drain line, said electrically controlled valve being connected to and controlled by said electronic controller.

7. A method of disposing of food particles in a dishwasher comprising:
concentrating fine food particles in a sump of the dishwasher during a wash cycle;
mounting a chopping blade on a common axis with an impeller of a drain pump;
rotating said impeller and said chopping blade to drain water and food particles from said sump; and
chopping food particles passing by said chopping blade.

8. The method of claim 7 further comprising opening and closing an electrically controlled valve in the discharge line from said drain pump in response to signals from an electronic controller for said dishwasher.

9. The method of claim 8 further comprising pulsing said drain pump on and off during a wash cycle of said dishwasher to chop said food particles prior to the discharge, while maintaining said electrically controlled valve closed.

10. The method of claim 8 further comprising:
pulsing said drain pump on and off during a wash cycle of said dishwasher to chop said food particles; and
opening and closing said electrically controlled valve in the discharge line during said pulsing of said drain pump in response to signals from said electronic controller.

11. The method of claim 7 further comprising venting air trapped by said drain pump impeller.

12. The method of claim 7 wherein concentrating fine food particles includes the step of removing food particles from the dishwasher wash water with a fine particle filter.

13. The method of claim 7 further comprising removing relatively large objects from the dishwasher wash water with a course filter before said large article objects reach said sump.

14. The method of claim 8 further comprising pulsing the electrically controlled valve in the discharge line on and off during the wash cycle of said dishwasher in response to signals from said electronic controller.
